(19) United States
(12) Patent Application Publication
(10) Pub. No.: US 2026/0235416 A1
(43) Pub. Date: Aug. 13, 2026

(54) A SYSTEM FOR LOCATING AND TRACKING FLOATING OBJECTS, AND METHODS THEREOF

(71) Applicant: Castus Technologies Inc., Wilmington, DE (US)

(72) Inventor: Mohamed ISMAIL, Miami, FL (US)

(21) Appl. No.: 19/160,614

(22) PCT Filed: Feb. 28, 2024
(86) PCT No.: PCT/IB2024/051903

§ 371 Date: Aug. 28, 2025

(51) Int. Cl. G01C 21/00; G06T 7/20; G06T 7/70; G06T 11/65

(52) U.S. Cl. CPC G01C 21/3852; G01C 21/3811; G06T 7/20; G06T 7/70; G06T 11/65; G06T 2200/24; G06T 2207/10036; G06T 2207/10048; G06T 2207/30181

(57) ABSTRACT

The present disclosure relates to a system for locating and tracking floating objects and methods thereof. In particular, the present disclosure relates to a method and system for locating and tracking objects floating submerged or non-submerged on or near the surface of marine environment. The system and method of the present invention provide for receiving data on the object's physical characteristics, mapping the search area in the water body, acquiring meteorological data for the search area, simulating and predicting the object's movement based on input data, creating a map of predicted locations with probabilities of containing the object, displaying the predictions on a graphical user interface, tracking the object based on the map and communicating the object's location to a rescue team.

### CROSS REFERENCE TO RELATED APPLICATIONS

This patent application claims the benefit of and priority to provisional U.S. Application No. 63/487,262, filed on 28 Feb. 2023 and entitled “A System for Locating and Tracking Floating Objects, and Methods Thereof,” which is incorporated herein by reference in its entirety.

### TECHNICAL FIELD

The present disclosure relates to systems and methods for locating and tracking floating or submerged objects.

### BACKGROUND

Physical oceanography has advanced in recent years with new developments in its theoretical and observational facets, making it possible to describe the physical behavior of the ocean with precision. Pollution in the ocean, and particularly in the field of plastics, such as the concentration of garbage in “trash patches” or “gyres,” has become a major issue as pollution production continues to increase globally. The majority of the technologies developed to remove pollution, e.g. plastic, from the ocean are mechanical and work by collecting floating objects using a floating barrier. The velocity and orientation of the collecting system's floating barrier can be affected by wind, waves, water movement, and currents. There is limited research on the global movement of floating debris and its aggregation in the gyres. Most expenses in marine plastic recycling are due to the search process for plastic, as it is difficult to locate and track plastic objects.

The contamination of the world's oceans poses a significant threat to marine ecosystems, with plastic pollution being a particularly pressing concern. To mitigate the impact of this issue, the development of effective strategies for removing and collecting debris from the ocean's surface is imperative.

The movement of ocean currents is influenced by a multitude of factors, including climatic patterns, Earth's rotation, and meteorological conditions, resulting in the formation of oceanic gyres. The buildup of garbage and debris in these gyres, commonly referred to as “trash patches,” has become a growing concern for the negative impact it has on marine life. To address this problem, various technologies have been devised to remove polluting objects, particularly plastic, from the ocean's surface, primarily relying on mechanical systems that collect floating objects through the use of collecting systems and floating barriers.

Efforts to locate floating trash in the ocean have employed various methods, including visual detection via aerial surveys, tracking of surface drifters, and the deployment of oceanographic research vessels equipped with nets and sensors. Despite these efforts, the current methods used to locate and track floating debris are often restricted by their resolution and processing times, as well as their reliance on historical data rather than real-time observations.

The lack of reliable methods for real-time tracking of floating debris hinders the ability to effectively clean up pollution hotspots and mitigate the impact of ocean pollution on marine ecosystems. Till now, there are no efficient strategies that can accurately locate and track garbage patches in a timely manner.

Therefore, there is a need for improved systems and methods which alleviate at least some of the problems outlined herein. The present invention seeks to provide an improved systems and methods for locating and tracking objects in a water body which alleviate at least some of the problems outlined herein.

### SUMMARY

The Summary section is not intended to identify key features or essential features of the claimed subject matter, nor is it intended to be used as an aid in determining the scope of the claimed subject matter. The disclosure relates to locating and tracking objects. More specifically, the claimed disclosure relates systems and methods for locating and tracking objects in a water body.

The claimed disclosure provides a solution in order to overcome a problem specifically arising in the realm of locating and tracking floating trash in marine environment. The present invention provides improved strategies that can accurately locate and track garbage patches in a real-time manner. The claimed disclosure overcomes the limitations of current detection tools and provides other benefits that will become clear to those skilled in the art from the foregoing description.

Accordingly, in one aspect, the embodiments of the present invention provide for a method for locating and tracking an object in a water body, comprising: receiving data on physical characteristics of the object, wherein the object is the target intended to locate; mapping of an intended area for search in the water body; acquiring meteorological data for the intended area for search in the water body; simulating and predicting, using an algorithm, the movement of the object in the intended area for search based on the received input data which comprises the meteorological data and the physical characteristics of the object; creating a map of predicted locations of the object in the intended area for search of the water body with a probability of containing the object at a specific time; displaying the predicted locations by simulation on a graphical user interface; and tracking the object in the intended area for search according to the created map.

In these embodiments, real-time simulation takes place to update the predicted locations of the object and continuously updating the created map on the graphical user interface in real-time. In some embodiments, a rescue team tracks and locates the object in the intended area for search for collection.

In the embodiments of the present disclosure, the object is floating, fully submerged or suspended near the surface of water. In these embodiments, the object is floating above the seabed.

In the embodiments of the present disclosure, the intended area for search is defined by a starting point or a trained historical model of movement.

In some embodiments, the floating object is a lost object. In these embodiments, the intended area for search is determined by a starting point and time-period where the object was lost. In some embodiments, the lost object is the black box of a plane or a ship. In these embodiments, the lost object is any object with buoyant force equal or more than force exerted due to the weight of an object with a relative density equal or less than the water above seabed.

In different embodiments, the method further predicting the movement of the floating object within a period of time. In these embodiments, the period of time comprises days before and/or after the start of the tracking and locating process. In these embodiments, the period of time can be automatically updated in real-time to create a map of predicted locations with higher accuracy.

In the embodiments of the present disclosure, the floating object comprises debris, plastic, garbage, oil or any object of any nature.

In some embodiments, the input data includes the meteorological data, high-resolution satellite IR spectrum imagery, marine circulation model, objects' movement projection model, population data, weather data, water slope and level. In these embodiments, the input data can be historical or projected or real-time data.

In the embodiments of the present invention, the detected locations of the object are shown on the graphical user interface showing real-time coordinates of the object in the water body. In these embodiments, the water body comprises ocean, sea, river, lake, stream, pond or any collection of water that allows an object to float or be submerged. In these embodiments, the water body is open water or coastal regions.

In another aspect, the present disclosure provides for a system for locating and tracking an object in a water body, comprising: one or more processing devices configured to: automatically receive data on physical characteristics of the object, wherein the object is the target intended to locate; automatically map an intended area for search in the water body; automatically acquire meteorological data for the intended area for search in the water body; automatically simulate and predict, using an algorithm, the movement of the object in the intended area for search based on the received input data which comprises the meteorological data and the physical characteristics of the object; automatically create a map of predicted locations of the object in the intended area for search of the water body with a probability of containing the object at a specific time; and automatically track the object in the intended area for search according to the created map; and a graphical user interface to display the predicted locations by simulation; one or more databases configured to store the collected data; and a communication unit for automatically transmitting the location of the intended object to a search and rescue team in real-time.

In some embodiments, the system further comprises a high-resolution satellite IR spectrum imagery to locate the intended object at a specific time and location. In other embodiments, the one or more processing devices are configured to process real-time simulation to update the predicted locations of the object and continuously updating the created map on the graphical user interface in real-time.

In one embodiment, the meteorological data include data from buoys devices sensory systems or high-resolution satellite IR spectrum imagery. In some embodiments, the meteorological data are automatically acquired and processed in real-time.

In the embodiments of this disclosure, the input data comprises meteorological data, high-resolution satellite IR spectrum imagery, marine circulation model, objects movement projection model, population data, weather data, rivers slope and level. In these embodiments, the input data is historical or projected or real-time data. In some embodiments, the input data further includes kinetic energy and high-resolution algorithms of water bodies.

In some embodiments, the object is floating, fully submerged or non-submerged on or near the surface of water body. In other embodiments, the floating object comprises debris, plastic, garbage, oil or any object of any nature. In different embodiments, probabilities of locating the object in a determined search area is calculated by inputting longitudes and latitudes.

In a different aspect, the present disclosure provides for a computer-readable medium having computer-executable instructions that, when used by one or more computing devices, cause the one or more computing devices to perform a method for locating and tracking an object in a water body, comprising: automatically receiving data on physical characteristics of the object, wherein the object is the target intended to locate; automatically mapping an intended area for search in the water body; automatically acquiring meteorological data for the intended area for search in the water body; simulating and predicting, using an algorithm, the movement of the object in the intended area for search based on the received input data comprises the meteorological data and the physical characteristics of the object; automatically creating a map of predicted locations of the object in the intended area for search of the water body with a probability of containing the object at a specific time; automatically tracking the object in the intended area for search according to the created map; displaying the predicted locations by simulation; transmitting the location of the intended object to a search and rescue team in real-time; and tracking and collecting the object in the intended area for search by the rescue team.

In some embodiments, the method further locating the intended object at a specific time and location by a high-resolution satellite IR spectrum imagery.

In the embodiments of this disclosure, the method comprises the one or more processing devices is processing in real-time simulation to update the predicted locations of the object and continuously updating the created map on the graphical user interface in real-time.

In some embodiments, the data from the one or more sensors is further processed through a processor or a processing unit embedded on a computing board for real-time processing.

In the embodiments of the present disclosure, the method further comprises automatically acquiring meteorological data and processing in real-time.

In some embodiments, the input data comprises meteorological factors, density of water, wavelength, wave peak, weather, kinetic energy of water body, level and slope of water body, currents of water body, wind stress, thermal buoyancy, salinity-induced buoyancy, waves, tides, Coriolis effect, and buoyancy. In these embodiments, the input data is historical or projected or real-time data. In other embodiments, the input data further includes kinetic energy and high-resolution algorithms of water bodies.

In some embodiments, the input data further comprises automatically received data from one or more sensors through an application programming interface (API).

In some embodiments, the floating object comprises debris, plastic, garbage, oil or any object of any nature. In embodiments of the present disclosure, probabilities of locating the object in a determined search area is calculated by inputting longitudes and latitudes.

In some embodiments, the object is floating, fully submerged or non-submerged on or near the surface of water body. In one embodiment, the object is floating above the seabed. In other embodiments, the intended area for search is defined by a starting point or a trained historical model of movement. In some embodiments, the floating object is a lost object. In these embodiments, the intended area for search is determined by a starting point and time-period where the object was lost. In other embodiments, the lost object is the black box of a plane or a ship. In these embodiments, wherein the lost object is any object with buoyant force equal or more than force exerted due to the weight of an object with a relative density equal or less than the water above seabed.

In some embodiments, the water body comprises ocean, sea, river, lake, stream, pond or any collection of water that allows an object to float or be submerged. In these embodiments, the water body is open water or coastal regions.

In simple language, the present invention provides for the determination of the trajectory of a floating object by evaluating its physical attributes and the various forces that influence its movement. A comprehensive understanding of the object's characteristics and the environmental factors that impact its movement, in conjunction with either a starting position or a historical model of its movements, allows for the estimation of its location.

Hereinafter the different embodiments and aspects of the present invention is described in detail, however the scope of the present invention should not be restricted to these descriptions, even with the addition to the following examples as appropriate without departing from the spirit of the present invention it may change implementation.

### BRIEF DESCRIPTION OF THE DRAWINGS

Illustrative embodiments of the present invention are described in detail below with reference to the attached drawing figures, and wherein:

FIG. 1 illustrates a diagram of an example device suitable for operation of an embodiment.

FIG. 2 is a block flow diagram showing steps involved in the method of locating and tracking an object according to an embodiment of the present invention.

### DETAILED DESCRIPTION

It is an object of the present invention to provide superior tools locating and tracking objects floating or submerged. More particularly, the embodiments of the present disclosure provide a system and method to locate and track objects floating or submerged or non-submerged in a water body.

Production of plastics has increased world widely. By 2050, it's estimated that the manufacturing of plastic would have tripled, making up a quarter of the world's oil usage. This illustrates the basic conflict between the many uses of plastic and their environmental impact on marine ecosystems. Apart from the plastic pollution conflict, floating of foreign object on the ocean tend to major pollutants at the present day as it ends up in oceanic and coastal environments.

Plastic pollution is a growing concern in our oceans. Plastic waste not only harms marine life, but also enters the food chain, affecting human health. It is important to reduce plastic use and increase recycling efforts to mitigate this issue. Additionally, controlling litter and properly disposing of waste can help prevent plastic from entering our oceans. Collective action is necessary to address this problem and find sustainable solutions for waste management.

Collectively, the embodiments of the present disclosure provide for a solution that overcomes the limitations and shortfalls of the current systems and methods for locating and tracking objects floating or submerged or non-submerged in a water body. In particular, the invention provides a user-friendly system and method to locate and track objects over a large area of water body, covers a large area, making it possible to track and locate objects in both open water and coastal regions. The embodiments of the present invention provide a system and method which can be used for a variety of applications, including tracking lost boats, ships, and other vessels, as well as monitoring marine wildlife and floating and submerged assets. Moreover, the present invention integrates seamlessly with other systems which allows for improved accessibility and usage.

It has been observed that there are five main ocean gyres with high concentrations of plastic and garbage debris, however, there are also smaller moving patches with higher plastic density. These floating patches of plastic and garbage are found above the seabed.

It is noted that an ocean gyre is a large system of circulating ocean currents, driven by wind and the Earth's rotation, that can trap floating debris, such as plastic, in the center of the circulation. While the concentration of plastic debris within a gyre is generally higher than in other areas of the ocean, there can still be significant variations in concentration within the gyre itself. Some local areas may have higher concentrations of plastic due to factors such as the location of sources of plastic pollution or the presence of other currents or features that trap the plastic. Other areas may have lower concentrations due to the action of currents or other processes that transport the plastic away from these areas. Overall, the distribution of plastic within a gyre can be highly variable and can be influenced by a range of meteorological, oceanographic, and other factors.

Typically, meteorological conditions such as wind, currents, temperature, precipitation, and tides can impact the movement and stability of floating objects in the ocean. Wind forces create waves and can cause objects to drift or change course. Ocean currents are influenced by factors such as wind, tides, and Earth's rotation and can also cause objects to drift or change course. Buoyancy is determined by water density, which is affected by temperature. Changes in temperature can cause objects to become more or less buoyant. Precipitation can affect an object's weight and stability, potentially leading to capsizing if it is not designed to handle the added weight. Tides, caused by the gravitational forces of the Moon and Sun, can cause objects to rise and fall, impacting their stability. The specific effects of meteorological conditions on an object depend on its size and design, as well as the specific meteorological conditions in the area.

Meteorological factors refer to the various elements of Earth's weather and climate that can affect the movement of objects floating on the surface of a body of water. These factors can include wind speed and direction, air temperature, humidity, atmospheric pressure, cloud cover, and precipitation. In the context of locating and tracking floating objects, meteorological data can be used to simulate the movement of the intended object based on its physical characteristics and the conditions of the water body in which it is located. This data can be gathered from a variety of sources, such as weather stations, buoys, sensory systems, or high-resolution satellite imagery. By considering the effects of meteorological factors on the movement of floating objects, it is possible to identify locations with a high probability of containing the intended object at a specific time and track its movement in real-time as the simulation continues.

Optionally, meteorological factors can be measured by ocean buoys that are floating platforms that are equipped with sensors to measure various meteorological and oceanographic factors in the ocean. These sensors can include thermistors to measure temperature, conductivity cells to measure salinity, current meters to measure current speed and direction, wave sensors to measure wave height and period, and wind sensors to measure wind speed and direction. The sensors on an ocean buoy are connected to a data logger, which records the data and stores it for later retrieval. The data logger may also include a processor that can perform basic calculations on the data, such as calculating average values or deriving additional parameters from the raw data. Some ocean buoys also have communication systems, such as satellite or radio transmitters, which allow the data to be transmitted in real-time to a central location for analysis. Ocean buoys are typically designed to be robust and durable, able to withstand harsh marine environments and operate for extended periods of time. They are usually anchored to the ocean floor using a mooring line or designed to drift with the currents, depending on the specific requirements of the deployment. Drifting buoys are equipped with GPS receivers, which allow their position to be tracked as they move with the currents. Advantageously, ocean buoys are important tools for measuring meteorological and oceanographic factors in the ocean, providing valuable data on factors such as temperature, salinity, currents, and waves. These data are used for a wide range of purposes, including weather forecasting, climate modeling, ocean modeling, and marine safety.

Meteorological factor can also be measured by satellites. As Satellites are equipped with a variety of sensors that allow them to measure meteorological factors such as temperature, humidity, and precipitation. Infrared sensors are able to measure the temperature of the Earth's surface and atmosphere by detecting the wavelengths of infrared radiation emitted by these objects. The temperature of an object is directly related to the amount of thermal energy it emits, so by measuring the infrared radiation emitted by the Earth, scientists can determine the temperature of the Earth's surface and atmosphere. Visible and near-infrared sensors can measure the reflectance of the Earth's surface, which is the amount of visible and near-infrared light that is reflected back into space. This can be used to identify different types of vegetation, land cover, and water bodies. For example, healthy vegetation typically reflects more visible and near-infrared light than bare soil or urban areas, so by measuring the reflectance of the Earth's surface, scientists can determine the types of vegetation present and track changes in vegetation health. Microwave sensors can measure the amount of microwave radiation emitted by the Earth's surface and atmosphere. Water vapor and other substances in the atmosphere absorb microwave radiation, so by measuring the amount of microwave radiation emitted by the Earth, scientists can detect the presence of water vapor and precipitation. In addition, microwave sensors can be used to measure sea surface temperature and soil moisture.

The meteorological data used in the embodiments of the present invention includes data from buoys, devices, sensory systems, or high-resolution satellite IR spectrum imagery, and can be sent in real-time to the locating and tracking system. In use, the data can also include marine circulation models, object movement projection models, population data, weather data, and water body slope and level data.

Application Programming Interface (API) is used in the embodiments of the present invention for locating and tracking floating objects. An API acts as an interface between the sensory systems and the main system, receiving the data collected by the sensory systems and forwarding it to the main system. API can be considered as a set of rules and protocols that are used to enable communication between two systems. In the present invention, the API acts as the communication link between the sensory systems and the main system, receiving the data collected by the sensory systems and forwarding it to the main system. One of the main advantages of using an API is to allow for modularity and separation of concerns. This means that the sensory systems can be developed and maintained independently, without affecting the main system. Moreover, the API allows for flexibility, as new sensory systems can be added, or existing ones can be modified without affecting the main system. Furthermore, using an API enables the system to receive data from multiple sources and combine them to form a comprehensive view of the floating objects in the ocean. This allows for a more accurate and real-time tracking of floating objects and helps to mitigate the impacts of ocean pollution.

Additionally, API serves as an intermediary between the data-generating source (such as satellites or ocean sensors) and the system of the invention. In other words, API acts as a bridge between the data source and the system, allowing the data to be transmitted in real-time. API acts as a set of protocols and routines that enable different components of the system to communicate with one another. In this case, API allows the data collected by the sensory systems to be transferred to the server. In some embodiments, the system of the present invention can then access the data through the API link in real-time, ensuring that the system is always up to date with the latest information. This type of architecture is called a client-server architecture. The sensory systems function as the data source (the server) and the system of the invention functions as the client. API provides a standardized way for the system to access and request data from the server. This enables the system to receive and process the data quickly and efficiently. When a surface object is hit by a wave, it appears to move forward and upward with the wave. However, as the wave moves on, the object falls back and forth in an orbital rotation, returning to its previous position. It is simpler to comprehend ocean waves as simply the outward manifestation of kinetic energy propagating through seawater if one imagines the water within a wave following the same pattern. In all actuality, the water in waves doesn't travel much by any means. Energy is the only thing that waves can carry across the ocean. The seafloor's disruption of the wave's orbital motion is the cause of this phenomenon. Not only does the surface water move in an orbit as a wave moves through water, but a column of water below it (down to half of the wave's wavelength) also moves in the same way. The lower portion of the wave slows down and compresses as the bottom approaches in shallow areas, pushing the wave's crest higher in the air. The crest comes crashing down as wave energy is dissipated into the surf when this imbalance in the wave reaches its breaking point. There are a few different kinds of ocean waves, which are typically categorized according to the energy source from which they originate. Surface waves are the most common because wind blows along the air-water interface, causing a disturbance that gradually grows as the wind blows and the wave crest rises.

Classically, satellites can use various wavelengths of the electromagnetic spectrum to detect objects floating in the ocean. One common technique is to use visible and near-infrared (NIR) wavelengths, as the reflection of sunlight off the surface of the water can be used to identify the presence of floating objects. When sunlight reflects off the surface of the water, it creates a characteristic pattern of reflection known as “specular reflection.” The presence of a floating object on the surface of the water will disrupt this pattern of reflection, as the object will absorb or scatter some of the sunlight. By analyzing the pattern of reflection, satellites can identify the presence of floating objects on the surface of the water. Satellites can also use radar to detect objects floating in the ocean. Radar works by emitting a radio frequency signal and measuring the time it takes for the signal to bounce back after it hits an object. By measuring the time delay and the strength of the returned signal, satellites can determine the distance, size, and shape of the object. The resolution and sensitivity of radar systems can be varied by adjusting the frequency of the emitted signal and the characteristics of the receiving antenna. Other techniques that satellites can use to detect objects floating in the ocean include using thermal infrared wavelengths to detect heat signatures or using multispectral sensors to identify the presence of specific materials or substances. For example, satellites could be equipped with sensors that can detect the presence of oil slicks on the surface of the water, or the presence of specific types of algae. These sensors work by measuring the reflection or emission of electromagnetic radiation at specific wavelengths, which can be used to identify the presence of specific materials or substances. Overall, satellites can use a variety of techniques to detect objects floating in the ocean, including using visible and NIR wavelengths, radar, thermal infrared wavelengths, and multispectral sensors. The specific technique used will depend on the size and type of object being detected, as well as the specific goals of the satellite mission.

In a first aspect, the embodiments of the present disclosure provide for a method for locating and tracking an object in a water body, comprising: receiving data on the object's physical characteristics, mapping the search area in the water body, acquiring meteorological data for the search area, simulating and predicting the object's movement based on input data, creating a map of predicted locations with probabilities of containing the object, displaying the predictions on a graphical user interface (GUI), and tracking the object based on the map.

In a second aspect, the embodiments of the present disclosure provide for a system for locating and tracking an object in a water body, comprising a processor that automatically receives data on the object's physical characteristics, maps the search area, acquires meteorological data, simulate and predict the object's movement, creates a map of predicted locations with probabilities, and tracks the object; a GUI to display the predictions; a storage device to store collected data; and a communication unit that transmits the object's location to a search and rescue team in real-time.

In a third aspect, the embodiments of the present disclosure provide for a computer-readable medium containing instructions that cause computing devices to perform a method for locating and tracking an object in a water body, including: automatically receiving data on the object's physical characteristics, automatically mapping the search area, acquiring meteorological data, simulating and predicting the object's movement, automatically creating a map of predicted locations with probabilities, automatically tracking the object, displaying the predictions, transmitting the object's location to a search and rescue team in real-time, and tracking and collecting the object by the rescue team.

Having briefly illustrated embodiments of the present disclosure, it is the aim of one of the aspects to provide for a method for locating and tracking floating objects above seabed. The method efficiently finds and tracks objects floating above seabed after objectively specifying drop down coordinates, volume of the object and density of the object. Moreover, the method of the present invention improves missions to collect a specific object by providing its starting point, density, and volume. This method predicts coordinates of patches floating above seabed at current time and capable of tracking these patches. The method of the present invention tracks coordinates with high probability of containing patches for effectively helping in collecting these patches floating above seabed.

In some embodiments, the method of the present invention locates and tracks coordinates with high probability of containing an object after specifying a starting dropped point, volume, and density considering meteorological factors of water bodies and considering their current and circulation which is floating above seabed.

In the first aspect of the present invention, the embodiments provide for a method for locating and tracking an object in a marine environment, comprising: receiving data on physical characteristics of the object, wherein the object is the target intended to locate; mapping of an intended area for search in the water body; acquiring meteorological data for the intended area for search in the water body; simulating and predicting, using an algorithm, the movement of the object in the intended area for search based on the received input data which comprises the meteorological data and the physical characteristics of the object; creating a map of predicted locations of the object in the intended area for search of the water body with a probability of containing the object at a specific time; displaying the predicted locations by simulation on a graphical user interface; and tracking the object in the intended area for search according to the created map.

In these embodiments, real-time simulation takes place to update the predicted locations of the object and continuously updating the created map on the graphical user interface in real-time. In some embodiments, a rescue team tracks and locates the object in the intended area for search for collection.

In the embodiments of the present disclosure, the object is floating, fully submerged or suspended near the surface of water. In these embodiments, the object is floating above the seabed.

In the embodiments of the present disclosure, the intended area for search is defined by a starting point or a trained historical model of movement.

In some embodiments, the floating object is a lost object. In these embodiments, the intended area for search is determined by a starting point and time-period where the object was lost. In some embodiments, the lost object is the black box of a plane or a ship. In these embodiments, the lost object is any object with buoyant force equal or more than force exerted due to the weight of an object with a relative density equal or less than the water above seabed.

In different embodiments, the method further predicting the movement of the floating object within a period of time. In these embodiments, the period of time comprises days before and/or after the start of the tracking and locating process. In these embodiments, the period of time can be automatically updated in real-time to create a map of predicted locations with higher accuracy.

In the embodiments of the present disclosure, the floating object comprises debris, plastic, garbage, oil or any object of any nature.

In some embodiments, the input data includes the meteorological data, high-resolution satellite IR spectrum imagery, marine circulation model, objects' movement projection model, population data, weather data, water slope and level. In these embodiments, the input data can be historical or projected or real-time data.

In the embodiments of the present invention, the detected locations of the object are shown on the graphical user interface showing real-time coordinates of the object in the water body. In these embodiments, the water body comprises ocean, sea, river, lake, stream, pond or any collection of water that allows an object to float or be submerged. In these embodiments, the water body is open water or coastal regions.

In some embodiments, the data used in includes historical or projected or real-time meteorological data, high-resolution satellite IR spectrum imagery, marine circulation models, object movement projection models, population data, weather data, and rivers' slope and level. In embodiments, data from a variety of sources to improve the accuracy and reliability of the simulations and predictions can be used.

The second aspect of the present disclosure provides for a system for locating and tracking an object in a water body, comprising: one or more processing devices configured to: automatically receive data on physical characteristics of the object, wherein the object is the target intended to locate; automatically map an intended area for search in the water body; automatically acquire meteorological data for the intended area for search in the water body; automatically simulate and predict, using an algorithm, the movement of the object in the intended area for search based on the received input data which comprises the meteorological data and the physical characteristics of the object; automatically create a map of predicted locations of the object in the intended area for search of the water body with a probability of containing the object at a specific time; and automatically track the object in the intended area for search according to the created map; and a graphical user interface to display the predicted locations by simulation; one or more databases configured to store the collected data; and a communication unit for automatically transmitting the location of the intended object to a search and rescue team in real-time.

In some embodiments, the system further comprises a high-resolution satellite IR spectrum imagery to locate the intended object at a specific time and location. In other embodiments, the one or more processing devices are configured to process real-time simulation to update the predicted locations of the object and continuously updating the created map on the graphical user interface in real-time.

In one embodiment, the meteorological data include data from buoys devices sensory systems or high-resolution satellite IR spectrum imagery. In some embodiments, the meteorological data are automatically acquired and processed in real-time.

In the embodiments of this disclosure, the input data comprises meteorological data, high-resolution satellite IR spectrum imagery, marine circulation model, objects movement projection model, population data, weather data, rivers slope and level. In these embodiments, the input data is historical or projected or real-time data. In some embodiments, the input data further includes kinetic energy and high-resolution algorithms of water bodies.

In the embodiments of this disclosure, the system further receives the input data from one or more sensors automatically in real-time through an application programming interface (API).

In some embodiments, the object is floating, fully submerged or non-submerged on or near the surface of water body. In other embodiments, the floating object comprises debris, plastic, garbage, oil or any object of any nature. In different embodiments, probabilities of locating the object in a determined search area is calculated by inputting longitudes and latitudes.

The third aspect of the present disclosure provides for a computer-readable medium having computer-executable instructions that, when used by one or more computing devices, cause the one or more computing devices to perform a method for locating and tracking an object in a water body, comprising: automatically receiving data on physical characteristics of the object, wherein the object is the target intended to locate; automatically mapping an intended area for search in the water body; automatically acquiring meteorological data for the intended area for search in the water body; simulating and predicting, using an algorithm, the movement of the object in the intended area for search based on the received input data comprises the meteorological data and the physical characteristics of the object; automatically creating a map of predicted locations of the object in the intended area for search of the water body with a probability of containing the object at a specific time; automatically tracking the object in the intended area for search according to the created map; displaying the predicted locations by simulation; transmitting the location of the intended object to a search and rescue team in real-time; and tracking and collecting the object in the intended area for search by the rescue team.

In some embodiments, the method further locating the intended object at a specific time and location by a high-resolution satellite IR spectrum imagery.

In the embodiments of this disclosure, the method comprises the one or more processing devices is processing in real-time simulation to update the predicted locations of the object and continuously updating the created map on the graphical user interface in real-time.

In some embodiments, the data from the one or more sensors is further processed through a processor or a processing unit embedded on a computing board for real-time processing.

In the embodiments of the present disclosure, the method further comprises automatically acquiring meteorological data and processing in real-time.

In some embodiments, the input data comprises meteorological factors, density of water, wavelength, wave peak, weather, kinetic energy of water body, level and slope of water body, currents of water body, wind stress, thermal buoyancy, salinity-induced buoyancy, waves, tides, Coriolis effect, and buoyancy. In these embodiments, the input data is historical or projected or real-time data. In other embodiments, the input data further includes kinetic energy and high-resolution algorithms of water bodies.

In some embodiments, the floating object comprises debris, plastic, garbage, oil or any object of any nature. In embodiments of the present disclosure, probabilities of locating the object in a determined search area is calculated by inputting longitudes and latitudes.

In some embodiments, the object is floating, fully submerged or non-submerged on or near the surface of water body. In one embodiment, the object is floating above the seabed. In other embodiments, the intended area for search is defined by a starting point or a trained historical model of movement. In some embodiments, the floating object is a lost object. In these embodiments, the intended area for search is determined by a starting point and time-period where the object was lost. In other embodiments, the lost object is the black box of a plane or a ship. In these embodiments, wherein the lost object is any object with buoyant force equal or more than force exerted due to the weight of an object with a relative density equal or less than the water above seabed.

In some embodiments, the water body comprises ocean, sea, river, lake, stream, pond or any collection of water that allows an object to float or be submerged. In these embodiments, the water body is open water or coastal regions.

The core idea of the system of the present invention is to predict the location of floating objects in a liquid environment based on a set of inputs. The inputs to the system include meteorological data of the liquid, such as water temperature, currents, tides and waves, as well as physical characteristics of the object, such as size, weight, and material composition. The system also leverages historical data and models to make more accurate predictions. This historical data can include the object's previous trajectory, or the behavior of similar objects in similar conditions, allowing the system of the present invention to fine-tune its predictions and improve accuracy.

The present invention begins by first collecting data on the environment and the object being tracked. This data can be obtained from sensors placed in the environment, such as those used by buoys sensors to collect meteorological data, or from external sources, such as satellite IR spectrum imageries. The API facilitates the transfer of data from the sensory systems to the system in real-time, ensuring the accuracy and reliability of the tracking information. Once the data is collected, it is fed into the system of the present invention, which uses it to calculate the expected location of the object.

The system of the present invention takes into account the physical characteristics of the object and the environment and predicts its movement over time based on these factors. The system updates the predicted location of the object as more data is received and new calculations are made. The historical data and models are incorporated into the system to improve the accuracy of the predictions.

The output is the predicted location of the object, which can then be displayed on a map or used for other purposes, such as guiding a search and recovery mission. The system can be run in real-time, continuously updating the predicted location of the object as new data is received. This allows for real-time tracking and monitoring of floating objects in a liquid environment, making it possible to locate and recover them even in challenging conditions.

The present disclosure allows for efficient and cost-effective locating and tracking of floating objects in marine environments, improving search and rescue efforts and addressing the problem of marine debris and pollution.

The major advantage of the present disclosure is that it provides for a method and system for real-time computing for locating and tracking floating and submerged objects in marine environments.

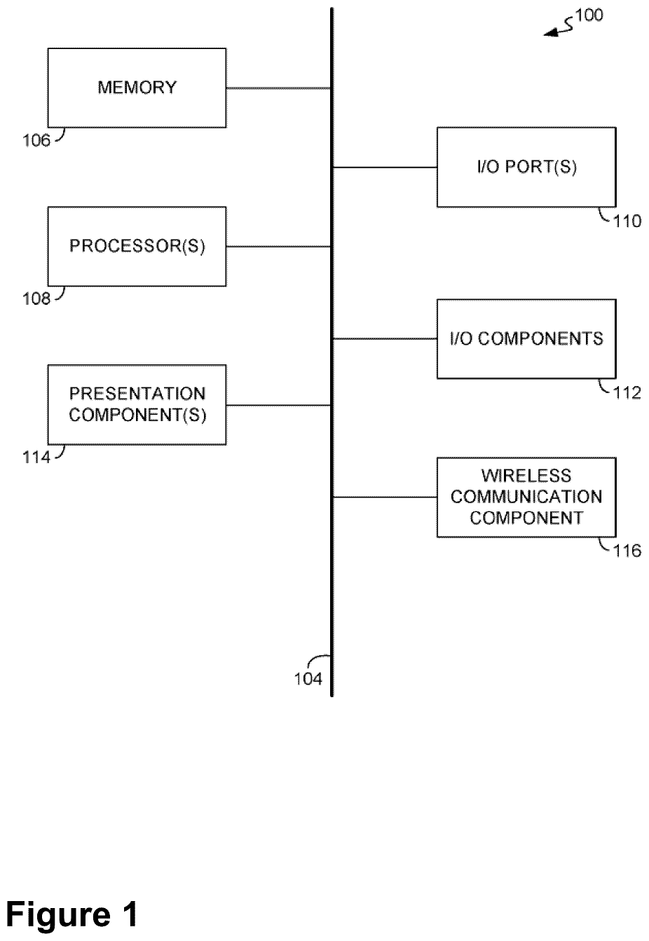

Turning to FIG. 1, it depicts a block diagram of a device 100 suitable to implement embodiments of the present invention. It will be understood by those of ordinary skill in the art that device 100 is just one non-limiting example of a suitable device and is not intended to limit the scope of use or functionality of the present invention. Similarly, device 100 should not be interpreted as imputing any dependency and/or any requirements with regard to each component and combination(s) of components illustrated in FIG. 1. It will be appreciated by those having ordinary skill in the art that the connections illustrated in FIG. 1 may comprise other methods, hardware, software, and/or devices for establishing a communications link between the components, devices, systems, and entities. Although the connections are depicted using one or more solid lines, it will be understood by those having ordinary skill in the art that the connections of FIG. 1 may be hardwired or wireless and may use intermediary components that have been omitted or not included in FIG. 1 for simplicity's sake. As such, the absence of components from FIG. 1 should not be interpreted as limiting the present invention to exclude additional components and combination(s) of components. Moreover, though devices and components are represented in FIG. 1 as singular devices and components, it will be appreciated that some embodiments may include a plurality of the devices and components such that FIG. 1 should not be considered as limiting the number of a devices or components.

Continuing, device 100 may be in the form of a server, in some embodiments. Although illustrated as one component in FIG. 1, the present invention may utilize a plurality of local servers and/or remote servers in device 100. The server may include components such as a processing unit, internal system memory, and a suitable system bus for coupling to various components, including a database or database cluster. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server may include or may have access to computer-readable media. Computer-readable media may be any available media that may be accessed by server. Computer-readable media may include one or more volatile media, nonvolatile media, removable media, or non-removable media. By way of a non-limiting example, computer-readable media may include computer storage media and/or communication media. Non-limiting examples of computer storage media may include one or more of volatile media, nonvolatile media, removable media, or non-removable media, may be implemented in any method and/or any technology for storage of information, such as computer-readable instructions, data structures, program modules, or other data. In this regard, non-limiting examples of computer storage media may include Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage device, or any other medium which may be used to store information and which may be accessed by the server. Generally, computer storage media is non-transitory such that it does not comprise a signal per se.

Communication media may embody computer-readable instructions, data structures, program modules, and/or other data in a modulated data signal, such as a carrier wave or other transport mechanism. Communication media may include any information delivery media. As used herein, the term “modulated data signal” refers to a signal that has one or more of its attributes set or changed in such a manner as to encode information in the signal. Non-limiting examples of communication media may include wired media, such as a wired network connection, a direct-wired connection, and/or a wireless media, such as acoustic, radio frequency (RF), infrared, and other wireless media. Combinations of any of the above also may be included within the scope of computer-readable media.

Continuing to FIG. 1, the block diagram of device 100 suitable for providing packing instructions is provided, in accordance with an embodiment of the technology. It should be noted that although some components depicted in FIG. 1 are shown in the singular, they may be plural, and the components may be connected in a different, including distributed, configuration. For example, device 100 may include multiple processors and/or multiple sensors. As shown in FIG. 1, device 100 includes a bus 104 that may directly or indirectly connect different components together, including memory 106 and a processor 108. In further embodiments, the device 100 may include one or more of an input/output (I/O) port 110, I/O component 112, presentation component 114, or wireless communication component 116, such as a sensor or other device capable of sensing measurements as previously discussed, and capable of wireless and/or wired transmissions. The device 100 may be coupled to a power supply 118, in some embodiments.

Memory 106 may take the form of the memory components described herein. Thus, further elaboration will not be provided here, but it should be noted that memory 106 may include any type of tangible medium that is capable of storing information, such as a database. A database may include any collection of records, data, and/or other information, such as the algorithm(s) discussed herein and continuous data. In one embodiment, memory 106 may include a set of computer-executable instructions that, when executed, facilitate various functions or steps disclosed herein. These instructions will variously be referred to as “instructions” or an “application” for short. Processor 108 may actually be multiple processors that may receive instructions and process them accordingly. Presentation component 114 may include a display, a speaker, a screen, a portable digital device, and/or other components that may present information through visual (e.g., a display, a screen, a lamp, a light-emitting diode (LED), a graphical user interface (GUI), and/or even a lighted keyboard), auditory (e.g., a speaker), haptic feedback, and/or other tactile cues. Additionally or alternatively, presentation component 114 may include the ability to generate and communicate alerts as previously discussed herein. Wireless communication component 116 may facilitate communication with a network as previously described herein. Additionally or alternatively, the wireless communication component 116 may facilitate other types of wireless communications, such as Wi-Fi, WiMAX, LTE, Bluetooth, and others. In various embodiments, the wireless communication component 116 may be configured to concurrently support multiple technologies.

I/O port 110 may take a variety of forms. Exemplary I/O ports may include a USB jack, a stereo jack, an infrared port, a firewire port, and/or other proprietary communications ports. I/O component 112 may comprise one or more sensors, keyboards, microphones, speakers, touchscreens, and/or any other item usable to directly or indirectly input data into the device 100. Power supply 118 may include batteries, fuel cells, and/or any other component that may act as a power source to supply power to device 100 or to other components.

Although internal components of device 100 are not illustrated for simplicity, those of ordinary skill in the art will appreciate that internal components and their interconnection are present in the device 100 of FIG. 1. Accordingly, additional details concerning the internal construction of the device 100 are not further disclosed herein.

Regarding FIG. 1, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should not be interpreted as limiting the present embodiments to exclude additional component(s) and/or combination(s) of components. Moreover, though devices and components in the figures may be represented as singular devices and/or components, it will be appreciated that some embodiments may include a plurality of devices and/or components such that the figures should not be considered as limiting the number of a devices and/or components.

It is noted that embodiments of the present invention described herein with reference to block diagrams and flowchart illustrations. However, it should be understood that each block of the block diagrams and/or flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

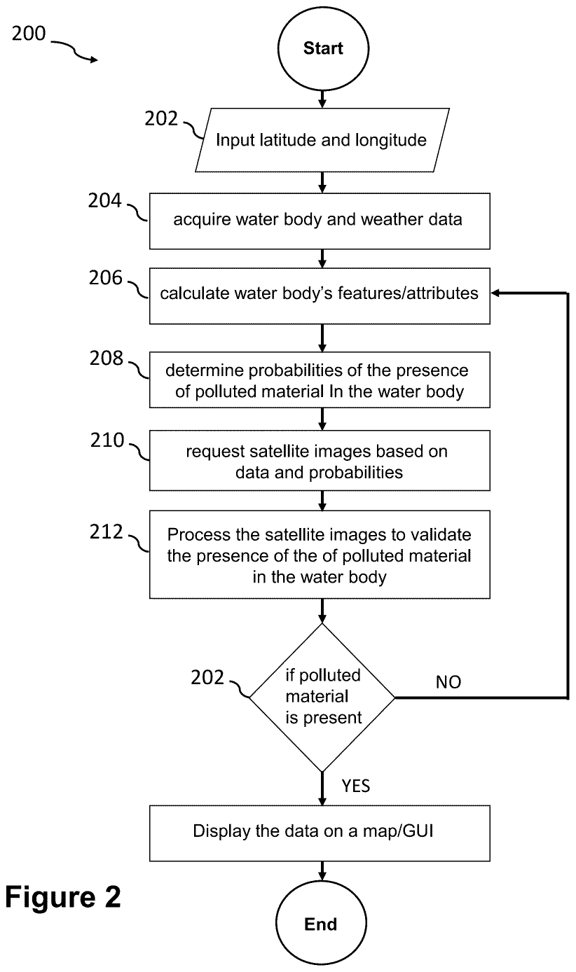

FIG. 2 depicts a process flow 200 aimed at locating and tracking floating and submerged objects in marine environments in alignment with an embodiment of the current disclosure. This process flow 200 can utilize any computer-based apparatus, for example, similar to the one detailed in FIG. 1. It is important to note that processes within the scope of the present disclosure might incorporate several additional steps, not explicitly outlined or depicted herein to maintain clarity. Although the description will primarily focus on locating and tracking of floating and submerged objects in marine environments as a method, it's pertinent to acknowledge that those with expertise in the field will understand that the present disclosure encompasses a system or software with units capable of executing the actions delineated below.

The process flow 200 begins by mapping an intended area for search of an object in a water body, i.e. collecting input latitude and longitude 202. In one embodiment, acquiring meteorological data for the intended area for search of the object in the water body takes place, i.e. acquire water body and weather data 204 and calculate water body's features/attributes 206. The object can be plastic. The features/information captured from the water include, but not limited to: meteorological factors, density of water, wavelength, wave peak, weather, kinetic energy of water body, level and slope of water body, currents of water body, wind stress, thermal buoyancy, salinity-induced buoyancy, waves, tides, Coriolis effect, and buoyancy. To capture non-plastic objects, in addition to the mentioned and collected information/features, other data will be needed for the method or system of the present invention such as a starting point, where the object were lost or thrown in the water; object dimensions, e.g. volume; and density.

Further, determining probabilities of the presence of the object, e.g. polluting material, in the water body 208 which simulates and predicts, using an algorithm, the movement of the object, in the intended area for search based on the received input data which comprises the meteorological data and the physical characteristics of the object. In return, the process flow 200 provides for requesting satellite images based on the acquired data and probabilities 210. By processing the received satellite images to validate the presence of the object 212, e.g. polluting material or plastic, it's possible to determine whether the object, is present in the search area or not 214. If the object, e.g. plastic, was not found, then the process flow 200 returns to step 206 for calculating additional water body's features/attributes repeating the process flow again. In case the object is found, the process flow 200 moves to predict the movement of the object in real time 216 providing live updates about the location of the object to be able to track the object, e.g. plastic or polluting material. The process flow 200 moves forward to display and visualize the map of predicted locations on a graphical user interface (GUI) 218 giving rise to the possibility of tracking the object in the intended area for search according to the created map.

The major advantage of the present disclosure is that it provides for a method and system for real-time computing for locating and tracking floating and submerged objects in marine environments.

As used herein, all headings are simply for organization and are not intended to limit the disclosure in any manner. The content of any individual section may be equally applicable to all sections.

1. A method for locating and tracking an object in a water body, comprising:
receiving data on physical characteristics of the object, wherein the object is a target intended to locate;
mapping of an intended area for search in the water body;
acquiring meteorological data for the intended area for search in the water body;
simulating and predicting, using an algorithm, the movement of the object in the intended area for search based on the received input data which comprises the meteorological data and the physical characteristics of the object;
creating a map of predicted locations of the object in the intended area for search of the water body with a probability of containing the object at a specific time;
displaying the predicted locations by simulation on a graphical user interface; and
tracking the object in the intended area for search according to the created map.

2. The method of claim 1, wherein real-time simulation takes place to update the predicted locations of the object and continuously updating the created map on the graphical user interface in real-time.

3. The method according to any preceding claim, wherein a rescue team tracks and locates the object in the intended area for search for collection.

4. The method according to claim 1, wherein the object is floating, fully submerged or suspended near the surface of water.

5. The method according to any preceding claim, wherein the object is floating above the bottom of the water body.

6. The method according to any preceding claim, wherein the bottom of the water body is seabed.

7. The method according to claim 1, wherein the intended area for search is defined by a starting point or a trained historical model of movement.

8. The method according to any preceding claim, wherein the object is a lost floating, fully submerged or suspended object.

9. The method according to any preceding claim, wherein the intended area for search is determined by a starting point and time-period where the object was lost.

10. The method according to any preceding claim, wherein the lost object is the black box of a plane or a ship.

11. The method according to claim 1, wherein the lost object is any object with buoyant force equal or more than force exerted due to the weight of an object with a relative density equal or less than the water above seabed.

12. The method according to claim 1, wherein the method further predicting the movement of the object within a period of time.

13. The method according to claim 1, wherein the period of time comprises days before and/or after the start of the tracking and locating process.

14. The method according to claim 1, wherein the period of time can be automatically updated in real-time to create a map of predicted locations with higher accuracy.

15. The method according to any preceding claim, wherein the object comprises debris, plastic, garbage, oil or any object of any nature.

16. The method according to claim 1, wherein the input data includes the meteorological data, high-resolution satellite IR spectrum imagery, marine circulation model, objects' movement projection model, population data, weather data, water slope and level.

17. The method according to claim 1, wherein the input data can be historical or projected or real-time data.

18. The method according to claim 1, wherein the detected locations of the object are shown on the graphical user interface showing real-time coordinates of the object in the water body.

19. The method according to any preceding claim, wherein the water body comprises ocean, sea, river, lake, stream, pond or any collection of water that allows an object to float or be submerged, non-submerged or suspended on or near the surface of water.

20. The method according to any preceding claim, wherein the water body is open water or coastal regions.

21. A system for locating and tracking an object in a water body, comprising:
one or more processing devices configured to:
automatically receive data on physical characteristics of the object, wherein the object is a target intended to locate;
automatically map an intended area for search in the water body;
automatically acquire meteorological data for the intended area for search in the water body;
automatically simulate and predict, using an algorithm, the movement of the object in the intended area for search based on the received input data which comprises the meteorological data and the physical characteristics of the object;
automatically create a map of predicted locations of the object in the intended area for search of the water body with a probability of containing the object at a specific time; and
automatically track the object in the intended area for search according to the created map; and
a graphical user interface to display the predicted locations by simulation;
one or more databases configured to store the collected data; and
a communication unit for automatically transmitting the location of the intended object to a search and rescue team in real-time.

22. The system of claim 21, wherein the system further comprises a high-resolution satellite IR spectrum imagery to locate the intended object at a specific time and location.

23. The system according to claim 21, wherein the one or more processing devices are configured to process real-time simulation to update the predicted locations of the object and continuously updating the created map on the graphical user interface in real-time.

24. The system according to claim 21, wherein the meteorological data include data from buoys devices sensory systems or high-resolution satellite IR spectrum imagery.

25. The system according to any one of claims 21-24, wherein meteorological data are automatically acquired and processed in real-time.

26. The system according to any one of claims 21-25, where the input data comprises meteorological data, high-resolution satellite IR spectrum imagery, marine circulation model, objects movement projection model, population data, weather data, rivers slope and level.

27. The system according to any one of claims 21-26, wherein the input data is historical or projected or real-time data.

28. The system according to any one of claims 21-27, wherein the input data further includes kinetic energy and high-resolution algorithms of water bodies.

29. The system according to any one of claims 21-28, wherein the object is floating, fully submerged or non-submerged on or near the surface of water body.

30. The system according to any one of claims 21-29, wherein the object comprises debris, plastic, garbage, oil or any object of any nature.

31. The system according to claim 21, wherein probabilities of locating the object in a determined search area is calculated by inputting longitudes and latitudes.

32. A computer-readable medium having computer-executable instructions that, when used by one or more computing devices, cause the one or more computing devices to perform a method for locating and tracking an object in a water body, comprising:
automatically receiving data on physical characteristics of the object, wherein the object is a target intended to locate;
automatically mapping an intended area for search in the water body;
automatically acquiring meteorological data for the intended area for search in the water body;
simulating and predicting, using an algorithm, the movement of the object in the intended area for search based on the received input data comprises the meteorological data and the physical characteristics of the object;
automatically creating a map of predicted locations of the object in the intended area for search of the water body with a probability of containing the object at a specific time;
automatically tracking the object in the intended area for search according to the created map;
displaying the predicted locations by simulation;
transmitting the location of the intended object to a search and rescue team in real-time; and
tracking and collecting the object in the intended area for search by the rescue team.

33. The computer-readable medium of claim 32, further locating the intended object at a specific time and location by a high-resolution satellite IR spectrum imagery.

34. The computer-readable medium according to claim 32, further comprises the one or more processing devices is processing in real-time simulation to update the predicted locations of the object and continuously updating the created map on the graphical user interface in real-time.

35. The computer-readable medium according to any one of claims 31-34, wherein further comprises automatically acquiring meteorological data and processing in real-time.

36. The computer-readable medium according to claim 32, where the input data comprises meteorological factors, density of water, wavelength, wave peak, weather, kinetic energy of water body, level and slope of water body, currents of water body, wind stress, thermal buoyancy, salinity-induced buoyancy, waves, tides, Coriolis effect, and buoyancy.

37. The computer-readable medium according to any one of claims 31-36, wherein the input data is historical or projected or real-time data.

38. The computer-readable medium according to claim 32, wherein the input data further includes kinetic energy and high-resolution algorithms of water bodies.

39. The computer-readable medium according to any one of claims 31-38, wherein the floating object comprises debris, plastic, garbage, oil or any object of any nature.

40. The computer-readable medium according to any one of claims 31-39, wherein probabilities of locating the object in a determined search area is calculated by inputting longitudes and latitudes.

41. The computer-readable medium according to any one of claims 31-40, wherein the object is floating, fully submerged or non-submerged on or near the surface of water body.

42. The computer-readable medium according to any one of claims 31-41, wherein the object is floating above the bottom of the water body.

43. The computer-readable medium according to claim 42, wherein the bottom of the water body is seabed.

44. The computer-readable medium according to any one of claims 31-43, wherein the intended area for search is defined by a starting point or a trained historical model of movement.

45. The computer-readable medium according to any one of claims 31-44, wherein the object is a lost object.

46. The computer-readable medium according to any one of claims 31-45, wherein the intended area for search is determined by a starting point and time-period where the object was lost.

47. The computer-readable medium according to any one of claims 31-46, wherein the lost object is the black box of a plane or a ship.

48. The computer-readable medium according to claim 32, wherein the lost object is any object with buoyant force equal or more than force exerted due to the weight of an object with a relative density equal or less than the water above seabed.

49. The computer-readable medium according to any one of claims 31-48, wherein the water body comprises ocean, sea, river, lake, stream, pond or any collection of water that allows an object to float or be submerged.

50. The computer-readable medium according to any one of claims 31-49, wherein the water body is open water or coastal regions.
